(19) United States
(12) Patent Application Publication
(10) Pub. No.: US 2025/0106740 A1
(43) Pub. Date: Mar. 27, 2025

(54) METHOD AND APPARATUS FOR PROVIDING SENSING SERVICE, AND COMMUNICATION DEVICE AND STORAGE MEDIUM

(71) Applicant: Beijing Xiaomi Mobile Software Co., Ltd., Beijing (CN)

(72) Inventors: Jianning LIU, Beijing (CN); Yang SHEN, Beijing (CN)

(21) Appl. No.: 18/727,937

(22) PCT Filed: Jan. 25, 2022
(86) PCT No.: PCT/CN2022/073853

§ 371 Date: Jul. 10, 2024

(51) Int. Cl. H04W 48/16; H04W 48/04; H04W 48/08

(52) U.S. Cl. CPC H04W 48/16; H04W 48/04; H04W 48/08

(57) ABSTRACT

A method for providing a sensing service is performed by a core network device. The method includes: receiving a sensing request sent by an access network device, wherein the sensing request is configured to request the sensing service; obtaining sensing service area restriction information, wherein the sensing service area restriction information indicates at least one of an area where the sensing service is forbidden to be initiated, or an area where the sensing service is allowed to be initiated; performing a predetermined operation according to the sensing service area restriction information, wherein the predetermined operation includes: accepting the sensing request or rejecting the sensing request; and sending a response message for the sensing service to the access network device, wherein the response message carries information for rejecting the sensing request or a configuration parameter of the sensing service.

### CROSS REFERENCE TO RELATED APPLICATION

The present application is a U.S. national stage application of International Application No. PCT/CN2022/073853, filed on Jan. 25, 2022, the content of which is incorporated herein by reference in its entirety.

### TECHNICAL FIELD

The present disclosure relates to, but is not limited to, the wireless communication technical field, and in particular to a method and apparatus for providing a sensing service, a communication device and a storage medium.

### BACKGROUND

The developments of Artificial intelligence (AI) technologies have promoted the intelligence of many industries, among which the sensing technology has become an important technical foundation for intelligence. The current radar-based sensing technology mainly relies on dedicated radar equipment, which is expensive and inflexible to deploy, and is mainly used in specific scenarios. With the developments of mobile communication technologies, the number of mobile base stations and terminals is huge, which can be used for object sensing.

### SUMMARY

Embodiments of the present disclosure provide a method and apparatus for providing a sensing service, a communication device and a storage medium.

According to a first aspect of embodiments of the present disclosure, there is provided a method for providing a sensing service, wherein the method is performed by a core network device and the method includes:
receiving a sensing request sent by an access network device, wherein the sensing request is used to request the sensing service;
obtaining sensing service area restriction information, wherein the sensing service area restriction information is used to indicate an area where the sensing service is forbidden and/or allowed to be initiated;
performing a predetermined operation according to the sensing service area restriction information,
wherein the predetermined operation includes: accepting the sensing request or rejecting the sensing request; and
sending a response message for the sensing service to the access network device, wherein the response message carries information for rejecting the sensing request or a configuration parameter of the sensing service.

According to a second aspect of embodiments of the present disclosure, there is provided a method for initiating a sensing service, wherein the method is performed by a terminal, and the method includes:
sending a sensing request to an access network device, wherein the sensing request is used to request the sensing service; and
receiving a response message for the sensing service sent by an access network device, wherein the response message carries information for rejecting the sensing request or a configuration parameter of the sensing service.

According to a third aspect of embodiments of the present disclosure, there is provided a method for initiating a sensing service, wherein the method is performed by an access network device, and the method includes:
sending a sensing request to a core network device, wherein the sensing request is used to request the sensing service; and
receiving a response message for the sensing service sent by the core network device, wherein the response message carries information for rejecting the sensing request or a configuration parameter of the sensing service.

According to a fourth aspect of embodiments of the present disclosure, there is provided an apparatus for providing a sensing service, wherein the apparatus includes:
a receiving module configured to receive a sensing request, wherein the sensing request is used to request a sensing service;
a processing module configured to: obtain sensing service area restriction information, wherein the sensing service area restriction information is used to indicate an area where the sensing service is forbidden and/or allowed to be initiated; and according to the sensing service area restriction information, perform a predetermined operation, wherein the predetermined operation includes: accepting the sensing request or rejecting the sensing request; and
a sending module configured to send a response message for the sensing service to the access network device, wherein the response message carries information for rejecting the sensing request or a configuration parameter of the sensing service.

According to a fifth aspect of embodiments of the present disclosure, there is provided an apparatus for initiating a sensing service, wherein the apparatus includes:
a sending module configured to send a sensing request, wherein the sensing request is used to request a sensing service; and
a receiving module configured to receive a response message, wherein the response message carries information for rejecting the sensing request or a configuration parameter of the sensing service.

According to a sixth aspect of embodiments of the present disclosure, there is provided an apparatus for initiating a sensing service, wherein the apparatus includes:
a sending module configured to send a sensing request to a core network device, wherein the sensing request is used to request a sensing service; and
a receiving module configured to receive a response message for the sensing service sent by the core network device, wherein the response message carries information for rejecting the sensing request or a configuration parameter of the sensing service.

According to a seventh aspect of embodiments of the present disclosure, there is provided a communication device, including:
a processor; and
a memory configured to store instructions executable by the processor;
wherein the processor is configured to, when the executable instructions are run, implement the method according to any one of embodiments of the present disclosure.

According to an eighth aspect of embodiments of the present disclosure, there is provided a computer storage medium. Computer executable programs are stored in the computer storage medium. When the executable programs are executed by a processor, the method according to any one of embodiments of the present disclosure is implemented.

### BRIEF DESCRIPTION OF THE DRAWINGS

FIG. 1 is a schematic structural diagram of a wireless communication system according to an example embodiment.

FIG. 2 is a schematic flowchart of a method for providing a sensing service according to an example embodiment.

FIG. 3a is a schematic flowchart of a method for providing a sensing service according to an example embodiment.

FIG. 3b is a schematic diagram showing a method for providing a sensing service according to an example embodiment.

FIG. 4 is a schematic flowchart of a method for providing a sensing service according to an example embodiment.

FIG. 5 is a schematic flowchart of a method for providing a sensing service according to an example embodiment.

FIG. 6 is a schematic flowchart of a method for providing a sensing service according to an example embodiment.

FIG. 7 is a schematic flowchart of a method for providing a sensing service according to an example embodiment.

FIG. 8 is a schematic flowchart of a method for providing a sensing service according to an example embodiment.

FIG. 9 is a schematic flowchart of a method for initiating a sensing service according to an example embodiment.

FIG. 10 is a schematic flowchart of a method for initiating a sensing service according to an example embodiment.

FIG. 11 is a schematic flowchart of a method for initiating a sensing service according to an example embodiment.

FIG. 12 is a schematic flowchart of a method for initiating a sensing service according to an example embodiment.

FIG. 13 is a schematic diagram showing the structure of an apparatus for providing a sensing service according to an example embodiment.

FIG. 14 is a schematic diagram showing the structure of an apparatus for initiating a sensing service according to an example embodiment.

FIG. 15 is a schematic diagram showing the structure of an apparatus for initiating a sensing service according to an example embodiment.

FIG. 16 is a schematic diagram showing the structure of a terminal according to an example embodiment.

FIG. 17 is a block diagram of a base station according to an example embodiment.

### DETAILED DESCRIPTION

Reference will now be made in detail to example embodiments, examples of which are illustrated in the accompanying drawings. When the following description refers to the accompanying drawings, the same numerals in different drawings refer to the same or similar elements unless otherwise indicated. The implementations described in the following example embodiments do not represent all implementations consistent with the embodiments of the present disclosure. Rather, they are merely examples of apparatuses and methods consistent with aspects of the disclosed embodiments as recited in the appended claims.

Terms used in the embodiments of the present disclosure are for the purpose of describing specific embodiments only, and are not intended to limit the embodiments of the present disclosure. As used in the examples of the present disclosure and the appended claims, singular forms “a/an” and “the” are also intended to include a plural form unless the context clearly indicates otherwise. It should also be understood that the term “and/or” as used herein refers to and includes any or all possible combinations of one or more of associated listed items.

It should be understood that although the terms first, second, third, etc. may be used to describe various information in the embodiments of the present disclosure, the information should not be limited by these terms. These terms are only used to distinguish information of the same type from each other. For example, without departing from the scope of the embodiments of the present disclosure, first information may also be called second information, and similarly second information may also be called first information. Depending on the context, the word “if” as used herein may be interpreted as “when” or “upon . . . ” or “in response to determining . . . ”.

For the purpose of simplicity and ease of understanding, the present disclosure uses the terms “greater than” or “less than” when representing a magnitude relationship. However, those skilled in the art can understand that the term “greater than” also encompasses the meaning of “greater than or equal to”, and “less than” also encompasses the meaning of “less than or equal to”.

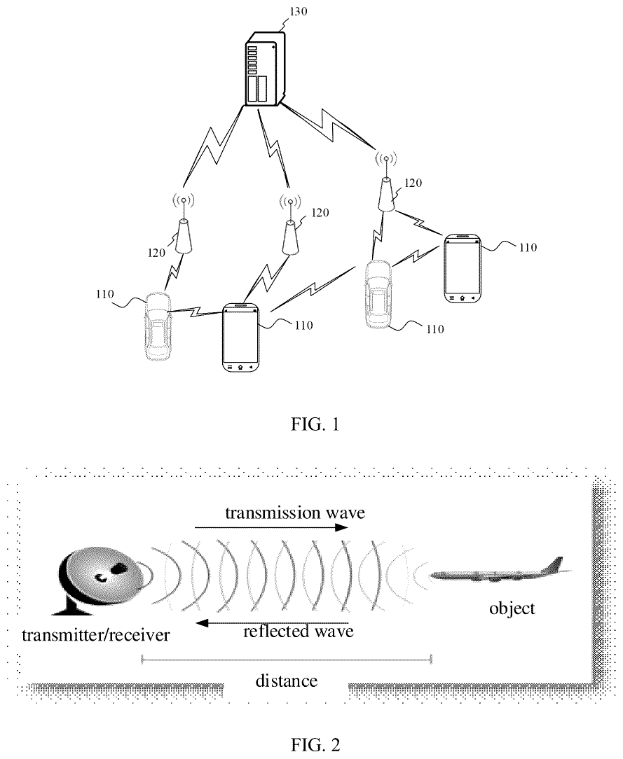

FIG. 1 shows a schematic structural diagram of a wireless communication system provided by an embodiment of the present disclosure. As shown in FIG. 1, the wireless communication system is a communication system based on a mobile communication technology, and the wireless communication system may include: several user equipment 110 and several base stations 120.

User equipment 110 may be a device that provides voice and/or data connectivity to a user. The user equipment 110 may communicate with one or more core networks via a Radio Access Network (RAN). The user equipment 110 may be an Internet of Things user equipment, such as a sensor device, a mobile phone, and a computer with an Internet of Things user equipment, for example, it may be a fixed, portable, pocket-sized, handheld, computer-built-in or vehicle-mounted device, for example, Station (STA), subscriber unit, subscriber station, mobile station, mobile, remote station, access point, remote user equipment (remote terminal), access user equipment (access terminal), user device (user terminal), user agent, user device, or user equipment. Alternatively, the user equipment 110 may be equipment of an unmanned aerial vehicle. Alternatively, the user equipment 110 may be a vehicle-mounted device, for example, a trip computer with a wireless communication function, or a wireless user device connected externally to a trip computer. Alternatively, the user equipment 110 may be a roadside device, for example, it may be a streetlight, a signal light or other roadside device with a wireless communication function.

A base station 120 may be a network side device in a wireless communication system. The wireless communication system may be a 4th generation mobile communication (4G) system, also known as a Long Term Evolution (LTE) system; or, the wireless communication system may be a 5G system, also called new radio system or 5G NR system. Alternatively, the wireless communication system may be a next-generation system of the 5G system. An access network in the 5G system may be called New Generation-Radio Access Network (NG-RAN).

The base station 120 may be an evolved base station (eNB) adopted in a 4G system. Alternatively, the base station 120 may be a base station (gNB) adopting a centralized and distributed architecture in the 5G system. When the base station 120 adopts a centralized and distributed architecture, it generally includes a central unit (CU) and at least two distributed units (DUs). The central unit is provided with a protocol stack of a Packet Data Convergence Protocol (PDCP) layer, a Radio Link Control (RLC) layer, and Media Access Control (MAC) layer protocol stack; the distributed unit is provided a physical (PHY) layer protocol stack; embodiments of the present disclosure do not limit the specific implementation of the base station 120.

A wireless connection may be established between the base station 120 and the user equipment 110 through a wireless air interface. In different implementations, the wireless air interface is a wireless air interface based on the fourth-generation mobile communication network technology (4G) standard; or, the wireless air interface is a wireless air interface based on the fifth-generation mobile communication network technology (5G) standard, such as the wireless air interface is a new air interface; alternatively, the wireless air interface may also be a wireless air interface based on a technical standard of a next-generation mobile communication network based on 5G.

In some embodiments, an End to End (E2E) connection may be established between user equipment 110. For example, Vehicle to Vehicle (V2V) communication, Vehicle to Infrastructure (V2I) communication and Vehicle to Pedestrian (V2P) communication in Vehicle to everything (V2X) communication and so on.

Here, the above user equipment may be regarded as the terminal device in the following embodiments.

In some embodiments, the foregoing wireless communication system may further include a network management device 130.

Several base stations 120 are connected to the network management device 130 respectively. The network management device 130 may be a core network device in the wireless communication system. For example, the network management device 130 may be a Mobility Management Entity (MME) in Evolved Packet Core (EPC). Alternatively, the network management device may be other core network device, such as a Serving GateWay (SGW), a Public Data Network GateWay (PGW), a Policy and Charging Rules Function (PCRF) or Home Subscriber Server (HSS), etc. The implementation form of the network management device 130 is not limited in the embodiments of the present disclosure.

In order to facilitate the understanding of those skilled in the art, the embodiments of the present disclosure list a plurality of implementations to clearly illustrate the technical solutions of the embodiments of the present disclosure. Of course, those skilled in the art can understand that the plurality of implementations provided by the embodiments of the present disclosure may be performed independently, or combined with methods of other embodiments among embodiments of the present disclosure, or an implementation performed independently or implementations performed with other embodiments may be performed in combination with some methods in other related technologies; the embodiments of the present disclosure do not limit this.

In relevant scenarios of object sensing, due to privacy and/or security considerations, not all objects can or are allowed to be sensed, for example, military sensitive areas, special areas designated by traffic control departments or security departments, etc. In this case, a network needs to be able to effectively and flexibly control a sensing service.

In order to better understand the technical solutions described in any embodiment of the present disclosure, first, an application scenario in the related art is explained below.

Radio Detection and Ranging (Radar) is a detection system that uses radio waves to determine the distance (range), angle or velocity of an object. It may be used to detect aircraft, ships, spacecraft, missiles, motor vehicles, weather and terrain.

In an embodiment, referring to FIG. 2, the radar system includes:
a transmitter, producing electromagnetic waves in the radio or microwave domain; and
a receiver and processor to determine properties of an object.

Here, the current radar technology requires dedicated equipment, which is costly and cannot be deployed and used on demand. In addition, there is no unified frequency band usage management for frequency band usage, which can easily cause interference.

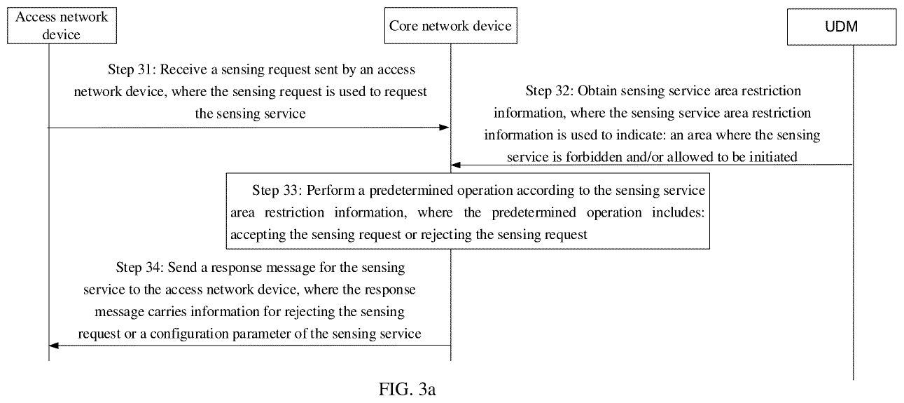

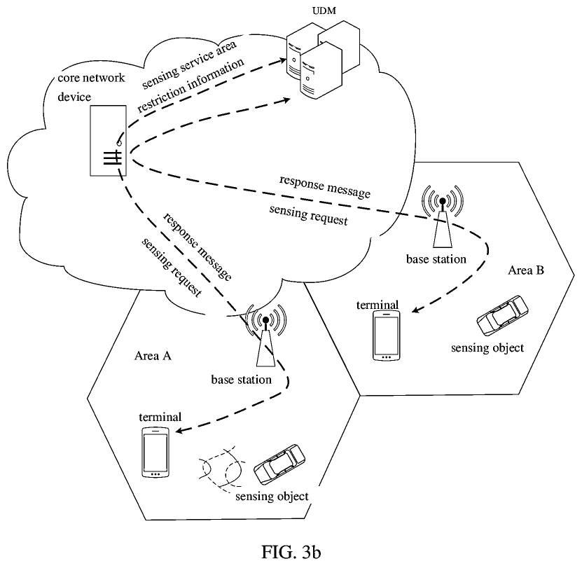

As shown in FIG. 3a, an embodiment provides a method for providing a sensing service. The method is performed by a core network device, and the method includes the following steps:

In step 31, a sensing request sent by an access network device is received. The sensing request is used to request the sensing service.

In step 32, sensing service area restriction information is obtained. The sensing service area restriction information is used to indicate: an area where the sensing service is forbidden and/or allowed to be initiated.

In step 33, a predetermined operation is performed according to the sensing service area restriction information. The predetermined operation includes: accepting the sensing request or rejecting the sensing request.

In step 34, a response message for the sensing service is sent to the access network device. The response message carries information for rejecting the sensing request or a configuration parameter of the sensing service.

In the embodiments of the present disclosure, a sensing request sent by an access network device is received, and the sensing request is used to request a sensing service; sensing service area restriction information is obtained, and the sensing service area restriction information is used to indicate: an area where the sensing service is forbidden and/or allowed to be initiated; a predetermined operation is performed according to the sensing service area restriction information: wherein the predetermined operation includes: accepting the sensing request or rejecting the sensing request; a response message for the sensing service is sent to the access network device, and the response message carries information for rejecting the sensing request or a configuration parameter of the sensing service. Here, since the predetermined operation is performed according to the sensing service area restriction information, when the requested sensing service is a sensing service in an area where the sensing service is forbidden to be initiated, the sensing request can be rejected, and information carrying the rejection of the sensing request is sent to the access network device; alternatively, when the requested sensing service is a sensing service in an area where the sensing service is allowed to be initiated, the sensing request can be accepted, and the configuration parameter of the sensing service is sent to the access network device. Compared with a method of always accepting a sensing request after receiving the sensing request, the technical solution in the present disclosure can adapt to the sensing service needs of different areas, and can effectively protect privacy and/or improve security.

Here, in step 31, the core network device may receive the sensing request sent by a terminal through the access network device. The access network device may be a base station.

Here, the terminal involved in the present disclosure may be, but is not limited to, a mobile phone, a wearable device, a vehicle-mounted terminal, a Road Side Unit (RSU), a smart home terminal, an industrial sensor device and/or a medical device, etc. In some embodiments, the terminal may be a Redcap terminal or a New Radio (NR) terminal with a predetermined version (for example, an R17 NR terminal).

The base station involved in the present disclosure may be an access device for a terminal to access a network. Here, the base station may be various types of base stations, for example, a base station of a third generation mobile communication (3G) network, a base station of a fourth generation mobile communication (4G) network, a base station of a fifth generation mobile communication (5G) network, or other evolved base stations.

The core network device in the present disclosure may be an Access Control And Mobility Management Function (AMF). It should be noted that the core network device is not limited to AMF, and may also be a device with a Sensing Function (SF). In an embodiment of the present disclosure, a device with the SF may be deployed as a communication node alone, or may be deployed in the AMF. A device with the SF may be understood as a logical node.

In an embodiment, a core network device receives a sensing request sent by an access network device, and the sensing request is used to request a sensing service. Sensing service area restriction information is obtained. The sensing service area restriction information is used to indicate: an area where a terminal is forbidden and/or allowed to initiate the sensing service. A predetermined operation is performed according to the sensing service area restriction information. The predetermined operation includes: accepting the sensing request or rejecting the sensing request. A response message for the sensing service is sent to the access network device. The response message carries information for rejecting the sensing request or a configuration parameter of the sensing service. Here, when rejecting the sensing request, a response message carrying a rejection of the sensing request may be sent to the access network device. When accepting the sensing request, a response message carrying the configuration parameter of the sensing service may be sent to the access network device.

Here, the access network device may be a base station.

In an embodiment, a core network device receives a sensing request sent by a terminal through a base station, and the sensing request is used to request a sensing service. Sensing service area restriction information is obtained. The sensing service area restriction information is used to indicate: an area where the terminal is forbidden and/or allowed to initiate the sensing service. A predetermined operation is performed according to the sensing service area restriction information. The predetermined operation includes: accepting the sensing request or rejecting the sensing request. A response message for the sensing service is sent to the base station. The response message carries information for rejecting the sensing request or a configuration parameter of the sensing service.

In an embodiment, a core network device receives a sensing request sent by a terminal through a base station, and the sensing request is used to request a sensing service. Sensing service area restriction information is obtained. The sensing service area restriction information is used to indicate: an area where the terminal is forbidden and/or allowed to initiate the sensing service. In response to the base station being located in the area where the terminal is forbidden to initiate the sensing service indicated by the sensing service area restriction information, the sensing request is rejected; or, in response to the base station being located in the area where the terminal is allowed to initiate the sensing service indicated by the sensing service area restriction information, the sensing request is accepted. In an embodiment, position information of different base stations is pre-set in the core network device, so that after receiving the sensing request sent by the terminal through the base station, based on a position relationship between the position indicated by the position information and the area where the terminal is forbidden and/or allowed to initiate the sensing service, it can be determined whether the base station is located in the area where the terminal is forbidden to initiate the sensing service. It should be noted that if the base station is not located in the area where the sensing service is allowed to be initiated, the base station is located in the area where the terminal is forbidden to initiate the sensing service.

In an embodiment, referring to FIG. 3b, a core network device receives a sensing request sent by a terminal through a base station. The sensing request is used to request a sensing service. The sensing request may carry position information of the terminal. Sensing service area restriction information is obtained. The sensing service area restriction information indicates: an area where the terminal is forbidden and/or allowed to initiate the sensing service. In response to the terminal being located in the area where the terminal is forbidden to initiate the sensing service indicated by the sensing service area restriction information (corresponding to Area B in FIG. 3b), the sensing request is rejected; or, in response to the terminal being located in the area where the terminal is allowed to initiate the sensing service indicated by the sensing service area restriction information (corresponding to Area A in FIG. 3b), the sensing request is accepted. In an embodiment, after receiving the sensing request sent by the terminal through the base station, the core network device may determine whether the base station is located in the area where the terminal is forbidden to initiate the sensing service based on a position relationship between the position indicated by the position information and the area where the terminal is forbidden and/or allowed to initiate the sensing service. It should be noted that if the terminal is not located in the area where the sensing service is allowed to be initiated, the terminal is located in the area where the terminal is forbidden to initiate the sensing service.

In an embodiment, a core network device receives a sensing request sent by a base station. The sensing request is used to request a sensing service. Sensing service area restriction information is obtained. The sensing service area restriction information is used to indicate: an area where the base station is forbidden and/or allowed to initiate the sensing service. A predetermined operation is performed based on the sensing service area restriction information. The predetermined operation includes: accepting the sensing request or rejecting the sensing request. A response message for the sensing service is sent to the base station. The response message carries information for rejecting the sensing request or a configuration parameter of the sensing service.

In an embodiment, a core network device receives a sensing request sent by a base station. The sensing request is used to request a sensing service. Sensing service area restriction information is obtained. The sensing service area restriction information indicates: an area where the base station is forbidden and/or allowed to initiate the sensing service. In response to the base station being located in the area where the terminal is forbidden to initiate the sensing service indicated by the sensing service area restriction information, the sensing request is rejected; or, in response to the base station being located in the area where the terminal is allowed to initiate the sensing service indicated by the sensing service area restriction information, the sensing request is accepted. In an embodiment, position information of different base stations is pre-set in the core network device, so that after receiving the sensing request sent by the terminal through the base station, it can be determined whether the base station is located in the area where the terminal is forbidden to initiate the sensing service based on a position relationship between the position indicated by the position information and the area where the terminal is forbidden and/or allowed to initiate the sensing service. It should be noted that if the base station is not located in the area where the sensing service is allowed to be initiated, the base station is located in the area where the terminal is forbidden to initiate the sensing service.

In an embodiment, a core network device receives a sensing request. The sensing request is used to request a sensing service. Authorization and privacy check are performed. In response to the authorization and privacy check being passed, a predetermined operation is performed according to obtained sensing service area restriction information. The sensing service area restriction information indicates: an area where the sensing service is forbidden and/or allowed to be initiated. The predetermined operation includes: accepting the sensing request or rejecting the sensing request. In response to the authorization and privacy check not being passed, the sensing request is rejected. Here, the core network device may send authorization and privacy check information to Unified Data Management (UDM), and receive a response message for the authorization and privacy check information returned by the UDM. The response message indicates: the authorization and privacy authentication being passed or the authorization and privacy authentication being not passed.

In an embodiment, a core network device receives a sensing request, and the sensing request is used to request a sensing service. Whether a network supports the sensing service is determined. In response to the network supporting the sensing service, a predetermined operation is performed according to the obtained sensing service area restriction information. The sensing service area restriction information indicates: an area where the sensing service is forbidden and/or allowed to be initiated. The predetermined operation includes: accepting the sensing request or rejecting the sensing request. In response to the network not supporting the sensing service, the sensing request is rejected. Here, the core network device may send a request for confirmation message to the UDM, and receive a response message returned by the UDM. The response message indicates that: the core network supports the sensing service or the core network does not support the sensing service.

In an embodiment, the core network device receives a sensing request, and the sensing request is used to request a sensing service. Whether the terminal subscribes to the sensing service is determined. In response to the terminal subscribing to the sensing service, a predetermined operation is performed according to the obtained sensing service area restriction information. The sensing service area restriction information is used to indicate: an area where the sensing service is forbidden and/or allowed to be initiated. The predetermined operation includes: accepting the sensing request or rejecting the sensing request. In response to the terminal not subscribing to the sensing service, the sensing request is rejected. Here, the core network device may send a request for confirmation message to the UDM, and receive a response message for the request for confirmation message returned by the UDM. The response message indicates that: the terminal has subscribed to the sensing service or the terminal has not subscribed to the sensing service.

In an embodiment, a sensing request is received, and the sensing request is used to request a sensing service. A predetermined operation is performed according to sensing service area restriction information. The sensing service area restriction information indicates: an area where the sensing service is forbidden and/or allowed to be initiated. The predetermined operation includes: accepting the sensing request or rejecting the sensing request. It is determined to reject the sensing request, and a response message is sent to the base station. The response message carries information for rejecting the sensing request. The response message may carry cause information for rejecting the request. The cause information may be at least one of the following information: information that the core network does not support the sensing service, information that the terminal is not authorized to initiate the sensing service, or information that the terminal does not subscribe to the sensing service.

In an embodiment, the sensing request carries one or more of the following information:
a terminal identity;
a sensing type;
a sensing Quality of Service (QoS);
position information of the terminal.

Here, the sensing type may be a type of sensing between terminals, a type of sensing between a terminal and a base station, or a type of sensing between a terminal and other object(s).

In an embodiment of the present disclosure, a sensing request sent by an access network device is received, and the sensing request is used to request a sensing service. Sensing service area restriction information is obtained. The sensing service area restriction information is used to indicate: an area where the sensing service is forbidden and/or allowed to be initiated. According to the sensing service area restriction information, a predetermined operation is performed. The predetermined operation includes: accepting the sensing request or rejecting the sensing request. A response message for the sensing service is sent to the access network device. The response message carries information for rejecting the sensing request or a configuration parameter of the sensing service. Here, since the predetermined operation is performed according to the sensing service area restriction information, when the requested sensing service is a sensing service in an area where the sensing service is forbidden to be initiated, the sensing request can be rejected, and information carrying the rejection of the sensing request is sent to the access network device; alternatively, when the requested sensing service is a sensing service in an area where the sensing service is allowed to be initiated, the sensing request can be accepted, and the configuration parameter(s) of the sensing service is(are) sent to the access network device. Compared with the method of always accepting a sensing request after receiving the sensing request, the technical solution in an embodiment of the present disclosure can adapt to the sensing service needs of different areas, and can effectively protect privacy and/or improve security.

It should be noted that those skilled in the art can understand that the methods provided in the embodiments of the present disclosure may be performed alone or may be performed together with some methods in the embodiments of the present disclosure or some methods in related art.

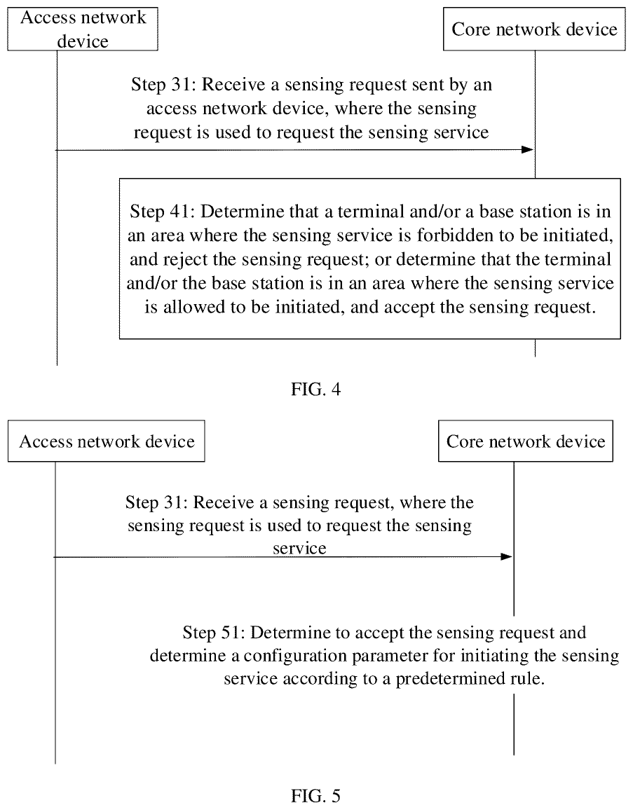

As shown in FIG. 4, an embodiment provides a method for providing a sensing service. The method is performed by a core network device, and the method includes:

In step 41, it is determined that a terminal and/or a base station is in an area where the sensing service is forbidden to be initiated, and the sensing request is rejected; or
it is determined that the terminal and/or base station is in an area where the sensing service is allowed to be initiated, and the sensing request is accepted.

In an embodiment, a core network device receives a sensing request sent by an access network device, and the sensing request is used to request a sensing service. Sensing service area restriction information is obtained. A predetermined operation is performed according to the sensing service area restriction information. The sensing service area restriction information is used to indicate: an area where the sensing service is forbidden and/or allowed to be initiated. The predetermined operation includes: accepting the sensing request or rejecting the sensing request. It is determined that the terminal and/or the base station is in an area where the sensing service is forbidden to be initiated, the sensing request is rejected. A response message for rejecting the sensing request is sent to the base station (or the response is sent to the terminal through the base station). The access network device is a base station.

In an embodiment, a core network device receives a sensing request sent by an access network device, and the sensing request is used to request a sensing service. Sensing service area restriction information is obtained. A predetermined operation is performed according to the sensing service area restriction information. The sensing service area restriction information indicates: an area where the sensing service is forbidden and/or allowed to be initiated. The predetermined operation includes: accepting the sensing request or rejecting the sensing request. It is determined that the terminal and/or the base station is in an area where the sensing service is allowed to be initiated, and the sensing request is accepted. A response message for accepting the sensing request is sent to the base station (or the response message is sent to the terminal through the base station). The access network device is the base station.

In an embodiment, a core network device receives a sensing request sent by a terminal through a base station, and the sensing request is used to request a sensing service. Sensing service area restriction information is obtained. The sensing service area restriction information is used to indicate: an area where the terminal is forbidden and/or allowed to initiate the sensing service. A predetermined operation is performed according to the sensing service area restriction information. The predetermined operation includes: accepting the sensing request or rejecting the sensing request. Exemplarily, it is determined that the terminal is in an area where the sensing service is forbidden to be initiated, the sensing request is rejected, and a response message for rejecting the sensing request is sent to the base station (or the response message is sent to the terminal through the base station). Alternatively, it is determined that the terminal is in an area where the sensing service is allowed to be initiated, the sensing request is accepted, and a response message for accepting the sensing request is sent to the base station (or the response message is sent to the terminal through the base station). Exemplarily, it is determined that the base station is in an area where the sensing service is forbidden to be initiated, the sensing request is rejected, and a response message for rejecting the sensing request is sent to the base station (or the response message is sent to the terminal through the base station). Alternatively, it is determined that the base station is in an area where the sensing service is allowed to be initiated, and the response message for the accepting the sensing request is sent.

In an embodiment, a core network device receives a sensing request sent by a base station, and the sensing request is used to request a sensing service. Sensing service area restriction information is obtained. The sensing service area restriction information is used to indicate: an area where the base station is forbidden and/or allowed to initiate a sensing service. A predetermined operation is performed according to the sensing service area restriction information. The predetermined operation includes: accepting the sensing request or rejecting the sensing request. Exemplarily, it is determined that the base station is in an area where the sensing service is forbidden to be initiated, the sensing request is rejected, and a response message for rejecting the sensing request is sent to the base station. Alternatively, it is determined that the base station is in an area where the sensing service is allowed to be initiated, the sensing request is accepted, and a response message for accepting the sensing request is sent to the base station.

It should be noted that those skilled in the art can understand that the methods provided in the embodiments of the present disclosure may be performed alone or may be performed together with some methods in the embodiments of the present disclosure or some methods in related art.

As shown in FIG. 5, an embodiment provides a method for providing a sensing service. The method is performed by a core network device, and the method includes:

In step 51, it is determined to accept a sensing request and a configuration parameter for initiating the sensing service is determined according to a predetermined rule.

In an embodiment, a core network device receives a sensing request, and the sensing request is used to request a sensing service. Sensing service area restriction information is obtained. A predetermined operation is performed according to the sensing service area restriction information. The sensing service area restriction information indicates: an area where the sensing service is forbidden and/or allowed to be initiated. The predetermined operation includes: accepting the sensing request or rejecting the sensing request. It is determined to accept the sensing request, and a configuration parameter for initiating the sensing service is determined according to a predetermined rule. Here, the configuration parameter may include a configuration parameter for a transmitter of the terminal to send a transmission wave and/or a configuration parameter for a receiver of the terminal to receive a reflected wave. Here, the predetermined rule may include mapping relationship information between sensing service type(s) and configuration parameter(s). A response message for the sensing service is sent to the access network device, and the response message carries the configuration parameter of the sensing service.

It should be noted that those skilled in the art can understand that the methods provided in the embodiments of the present disclosure may be performed alone or together with some methods in the embodiments of the present disclosure or some methods in related art.

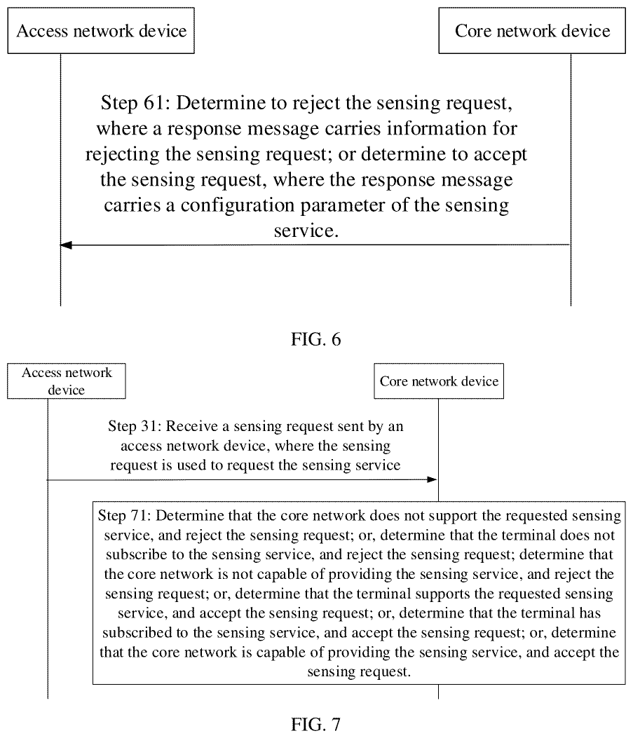

As shown in FIG. 6, an embodiment provides a method for providing a sensing service. The method is performed by a core network device, and the method includes:

In step 61, it is determined to reject a sensing request, and a response message carries information for rejecting the sensing request; or it is determined to accept the sensing request, and the response message carries a configuration parameter of the sensing service.

In an embodiment, it is determined to reject a sensing request, and a response message for the sensing request is sent to a base station. The response message carries information for rejecting the sensing request. Alternatively, it is determined to accept the sensing request, and a response message for the sensing request is sent to the base station. The response message carries a configuration parameter of the sensing service.

In some embodiments, it is determined that the core network does not support the requested sensing service and the sensing request is rejected; or, it is determined that the terminal does not subscribe to the sensing service and the sensing request is rejected; or, it is determined that the core network is not capable of providing the sensing service and the sensing request is rejected; or, it is determined that the terminal supports the requested sensing service and the sensing request is accepted; or, it is determined that the terminal has subscribed to the sensing service and the sensing request is accepted; or, it is determined that the core network is capable of providing the sensing service and the sensing request is accepted.

It should be noted that the inability of the core network to provide the sensing service may be caused by that the currently allocatable resource(s) of the core network is(are) not sufficient.

Here, the configuration parameter may include a configuration parameter for a transmitter of the terminal to send a transmission wave and/or a configuration parameter for a receiver of the terminal to receive a reflected wave.

In an embodiment, a core network device receives a sensing request sent by an access network device, and the sensing request is used to request a sensing service. Sensing service area restriction information is obtained. A predetermined operation is performed according to the sensing service area restriction information. The sensing service area restriction information is used to indicate: an area where the sensing service is forbidden and/or allowed to be initiated. The predetermined operation includes: accepting the sensing request or rejecting the sensing request. It is determined to reject the sensing request, and a response message is to the base station, where the response message carries information for rejecting the sensing request; or, it is determined to accept the sensing request, and a response message is sent to the base station, where the response message carries a configuration parameter of the sensing service. Here, the access network device is the base station.

In an embodiment, a core network device receives a sensing request, and the sensing request is used to request a sensing service. Sensing service area restriction information is obtained. A predetermined operation is performed according to the sensing service area restriction information. The sensing service area restriction information is used to indicate: an area where the sensing service is forbidden and/or allowed to be initiated. The predetermined operation includes: accepting the sensing request or rejecting the sensing request. It is determined that the terminal and/or the base station is in an area where the sensing service is forbidden to be initiated, the sensing request is rejected, and a response message for rejecting the sensing request is sent to the base station (or the response message is sent to the terminal through the base station).

In an embodiment, a core network device receives a sensing request, and the sensing request is used to request a sensing service. Sensing service area restriction information is obtained. A predetermined operation is performed according to the sensing service area restriction information. The sensing service area restriction information is used to indicate: an area where the sensing service is forbidden and/or allowed to be initiated. The predetermined operation includes: accepting the sensing request or rejecting the sensing request. It is determined that the terminal and/or the base station is in an area where the sensing service is allowed to be initiated, the sensing request is accepted, and a response message for accepting the sensing request is sent to the base station (or the response message is sent to the terminal through the base station).

In an embodiment, a core network device receives a sensing request sent by a terminal through a base station, and the sensing request is used to request a sensing service. Sensing service area restriction information is obtained. The sensing service area restriction information indicates: an area where the terminal is forbidden and/or allowed to initiate a sensing service. A predetermined operation is performed according to the sensing service area restriction information. The predetermined operation includes: accepting the sensing request or rejecting the sensing request. Exemplarily, it is determined that the terminal is in an area where the sensing service is forbidden to be initiated, the sensing request is rejected, and a response message for rejecting the sensing request is sent to the base station (or the response message is sent to the terminal through the base station). Alternatively, it is determined that the terminal is in an area where the sensing service is allowed to be initiated, the sensing request accepted, and a response message for accepting the sensing request is sent to the base station (or the response message is sent to the terminal through the base station). Exemplarily, it is determined that the base station is in an area where the sensing service is forbidden to be initiated, the sensing request is rejected, and a response message for rejecting the sensing request is sent to the base station (or the response message is sent to the terminal through the base station). Alternatively, it is determined that the base station is in an area where the sensing service is allowed to be initiated, and a response message for accepting the sensing request is sent.

In an embodiment, a core network device receives a sensing request sent by a base station, and the sensing request is used to request a sensing service. Sensing service area restriction information is obtained. The sensing service area restriction information is used to indicate: an area where the base station is forbidden and/or allowed to initiate the sensing service. A predetermined operation is performed according to the sensing service area restriction information. The predetermined operation includes: accepting the sensing request or rejecting the sensing request. Exemplarily, it is determined that the base station is in an area where the sensing service is forbidden to be initiated, the sensing request is rejected, and a response message for rejecting the sensing request is sent to the base station. Alternatively, it is determined that the base station is in an area where the sensing service is allowed to be initiated, the sensing request is accepted, and a response message for accepting the sensing request is sent to the base station.

It should be noted that those skilled in the art can understand that the methods provided in the embodiments of the present disclosure may be performed alone or may be performed together with some methods in the embodiments of the present disclosure or some methods in related art.

As shown in FIG. 7, an embodiment provides a method for providing a sensing service. The method is performed by a core network device, and the method includes:

In step 71, it is determined that the core network does not support the requested sensing service, and the sensing request is rejected; or, it is determined that the terminal does not subscribe to the sensing service, and the sensing request is rejected; it is determined that the core network is not capable of providing the sensing service, and the sensing request is rejected; or, it is determined that the terminal supports the requested sensing service, and the sensing request is accepted; or, it is determined that the terminal has subscribed to the sensing service, and the sensing request is accepted; or, it is determined that the core network is capable of providing the sensing service, and the sensing request is accepted.

It should be noted that the core network not supporting the requested sensing service is different from the core network being unable to provide the sensing service. The core network not supporting the requested sensing service may be that the core network itself does not support the function of the sensing service, and the inability to provide the sensing service may be that the core network supports the function of the sensing service but is unable to provide the sensing service due to temporarily insufficient allocated resource(s).

In an embodiment, a core network device receives a sensing request, and the sensing request is used to request a sensing service. Whether the core network supports the sensing service is determined. In response to the core network supporting the sensing service, a predetermined operation is performed according to obtained sensing service area restriction information. The sensing service area restriction information is used to indicate: an area where the sensing service is forbidden and/or allowed to be initiated. The predetermined operation includes: accepting the sensing request or rejecting the sensing request. In response to the core network not supporting the sensing service, the sensing request is rejected. Here, the core network device may send a request for confirmation message to the UDM, and receive a response message for the request for confirmation message returned by the UDM. The response message indicates that: the core network supports the sensing service or the core network does not support the sensing service.

In an embodiment, the core network device receives a sensing request, and the sensing request is used to request a sensing service. Whether the terminal subscribes to the sensing service is determined. In response to the terminal subscribing to the sensing service, a predetermined operation is performed according to obtained sensing service area restriction information. The sensing service area restriction information indicates: an area where the sensing service is forbidden and/or allowed to be initiated. The predetermined operation includes: accepting the sensing request or rejecting the sensing request. In response to the terminal not subscribing to the sensing service, the sensing request is rejected. Here, the core network device may send a request for confirmation message to the UDM, and receive a response message for the request for confirmation message returned by the UDM. The response message indicates that: the terminal subscribes to the sensing service or the terminal does not subscribe to the sensing service.

It should be noted that those skilled in the art can understand that the methods provided in the embodiments of the present disclosure may be performed alone or may be performed together with some methods in the embodiments of the present disclosure or some methods in related art.

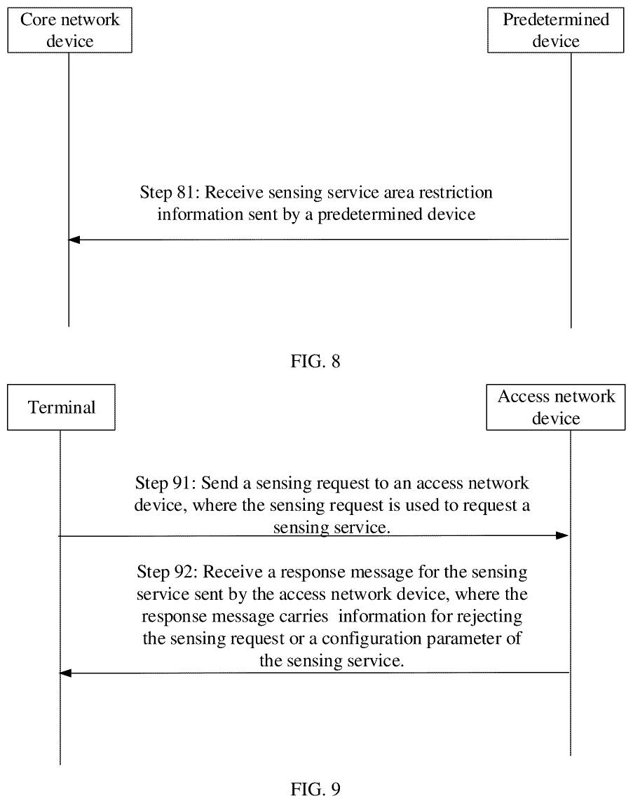

As shown in FIG. 8, an embodiment provides a method for providing a sensing service. The method is performed by a core network device, and the method includes:

In step 81, sensing service area restriction information sent by a predetermined device is received.

Here, the predetermined device may be a UDM.

In an embodiment, a core network device receives a sensing request sent by a terminal through a base station, and the sensing request is used to request a sensing service. Sensing service area restriction information sent by a predetermined device is received. The sensing service area restriction information is used to indicate: an area where the terminal is forbidden and/or allowed to initiate the sensing service. In response to the base station being located in an area where the terminal is forbidden to initiate the sensing service indicated by the sensing service area restriction information, the sensing request is rejected; or, in response to the base station being located in an area where the terminal is allowed to initiate the sensing service indicated by the sensing service area restriction information, the sensing request is accepted. In an embodiment, position information of different base stations is pre-set in the core network device, so that after receiving the sensing request sent by the terminal through the base station, it can be determined whether the base station is located in an area where the terminal is forbidden to initiate the sensing service based on a position relationship between the position indicated by the location information and the area where the terminal is forbidden and/or allowed to initiate the sensing service. It should be noted that if the base station is not located in an area where the sensing service is allowed to be initiated, the base station is located in an area where the terminal is forbidden to initiate the sensing service.

It should be noted that those skilled in the art can understand that the methods provided in the embodiments of the present disclosure may be performed alone or may be performed together with some methods in the embodiments of the present disclosure or some methods in related art.

As shown in FIG. 9, an embodiment provides a method for initiating a sensing service. The method is performed by a terminal and includes:

In step 91, a sensing request is sent to an access network device. The sensing request is used to request a sensing service.

In step 92, a response message for the sensing service sent by the access network device is received. The response message carries information for rejecting the sensing request or a configuration parameter of the sensing service.

Here, the configuration parameter may include a configuration parameter for a transmitter of the terminal to send a transmission wave and/or a configuration parameter for a receiver of the terminal to receive a reflected wave.

Here, the access network device may be a base station.

In an embodiment, a terminal sends a sensing request to a core network device through the base station, and the sensing request is used to request a sensing service. The core network device performs a predetermined operation based on obtained sensing service area restriction information. The sensing service area restriction information is used to indicate: an area where the sensing service is forbidden and/or allowed to be initiated. The predetermined operation includes: accepting the sensing request or rejecting the sensing request. The core network device determines to reject the sensing request, and the core network device sends a response message for the sensing request to the terminal through the base station, and the response message carries information for rejecting the sensing request. After receiving the response message, the terminal cannot perform a measurement operation of the sensing service.

In an embodiment, a terminal sends a sensing request to a core network device through the base station, and the sensing request is used to request a sensing service. The core network device performs a predetermined operation based on obtained sensing service area restriction information. The sensing service area restriction information is used to indicate: an area where the sensing service is forbidden and/or allowed to be initiated. The predetermined operation includes: accepting the sensing request or rejecting the sensing request. The core network device determines to accept the sensing request, and the core network device sends a response message to the terminal through the base station, and the response message carries a configuration parameter of the sensing service. After receiving the response message, the terminal determines that the response message carries the configuration parameter of the sensing service, and performs the measurement operation of the sensing service based on the configuration parameter.

In an embodiment, a base station sends a sensing request to a core network device, and the sensing request is used to request a sensing service. The core network device performs a predetermined operation according to obtained sensing service area restriction information. The sensing service area restriction information indicates: an area where the sensing service is forbidden and/or allowed to be initiated. The predetermined operation includes: accepting the sensing request or rejecting the sensing request. The core network device determines to reject the sensing request, and the core network device sends a response message to the base station, and the response message carries information for rejecting the sensing request. After receiving the response message, the base station cannot perform a measurement operation of the sensing service.

In an embodiment, a base station sends a sensing request to a core network device, and the sensing request is used to request a sensing service. The core network device performs a predetermined operation according to sensing service area restriction information. The sensing service area restriction information indicates: an area where the sensing service is forbidden and/or allowed to be initiated. The predetermined operation includes: accepting the sensing request or rejecting the sensing request. The core network device determines to accept the sensing request, and the core network device sends a response message to the base station, and the response message carries a configuration parameter of the sensing service. After receiving the response message, the base station determines that the response message carries the configuration parameter of the sensing service, and performs the measurement operation of the sensing service based on the configuration parameter.

It should be noted that those skilled in the art can understand that the methods provided in the embodiments of the present disclosure may be performed alone or may be performed together with some methods in the embodiments of the present disclosure or some methods in related art.

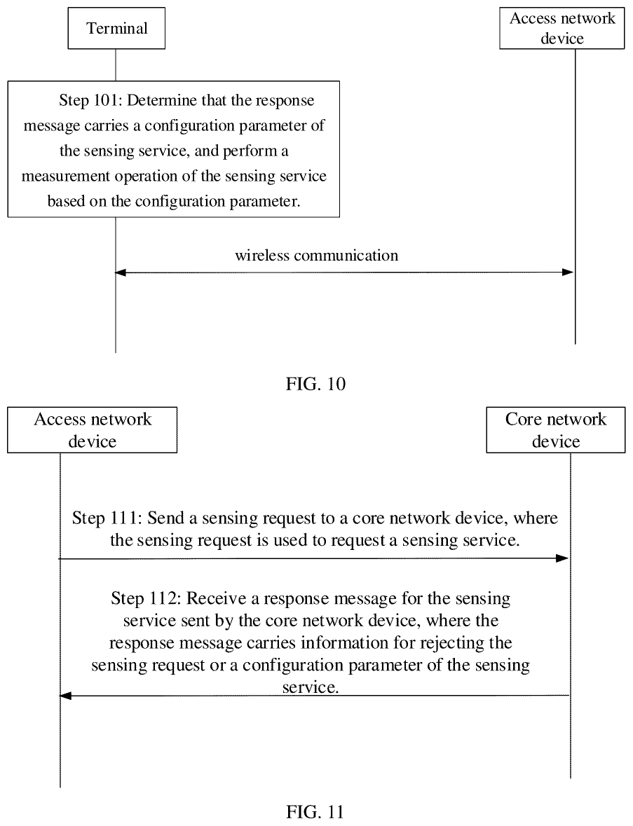

As shown in FIG. 10, an embodiment provides a method for initiating a sensing service. The method is performed by a terminal and includes:

In step 101, it is determined that a response message carries a configuration parameter of the sensing service, and a measurement operation of the sensing service is performed based on the configuration parameter.

In an embodiment, a terminal sends a sensing request to a core network device through a base station, and the sensing request is used to request a sensing service. The core network device performs a predetermined operation according to sensing service area restriction information. The sensing service area restriction information is used to indicate: an area where the sensing service is forbidden and/or allowed to be initiated. The predetermined operation includes: accepting the sensing request or rejecting the sensing request. The core network device determines to accept the sensing request, and the core network device sends a response message to the terminal through the base station, and the response message carries a configuration parameter of the sensing service. After receiving the response message, the terminal determines that the response message carries the configuration parameter of the sensing service, and performs a measurement operation of the sensing service based on the configuration parameter.

It should be noted that those skilled in the art can understand that the methods provided in the embodiments of the present disclosure may be performed alone or may be performed together with some methods in the embodiments of the present disclosure or some methods in related art.

As shown in FIG. 11, an embodiment provides a method for initiating a sensing service. The method is performed by an access network device, and the method includes:

In step 111, a sensing request is sent to a core network device. The sensing request is used to request a sensing service.

In step 112, a response message for the sensing service sent by the core network device is received. The response message carries information for rejecting the sensing request or a configuration parameter of the sensing service.

Here, the access network device may be a base station.

In an embodiment, a base station sends a sensing request to a core network device, and the sensing request is used to request a sensing service. The core network device performs a predetermined operation according to sensing service area restriction information. The sensing service area restriction information is used to indicate: an area where the sensing service is forbidden and/or allowed to be initiated. The predetermined operation includes: accepting the sensing request or rejecting the sensing request. The core network device determines to accept the sensing request, the core network device sends a response message to the base station, and the response message carries a configuration parameter of the sensing service. After receiving the response message, the base station determines that the response message carries the configuration parameter of the sensing service, and performs a measurement operation of the sensing service based on the configuration parameter.

It should be noted that those skilled in the art can understand that the methods provided in the embodiments of the present disclosure may be performed alone or may be performed together with some methods in the embodiments of the present disclosure or some methods in related art.

In order to better understand the embodiments of the present disclosure, the technical solutions of the present disclosure are further described below through an example embodiment.

### Example 1

It should be noted that an area where a sensing service is forbidden to be initiated and/or an area where a sensing service is allowed to be initiated may be configured in advance in a UDM.

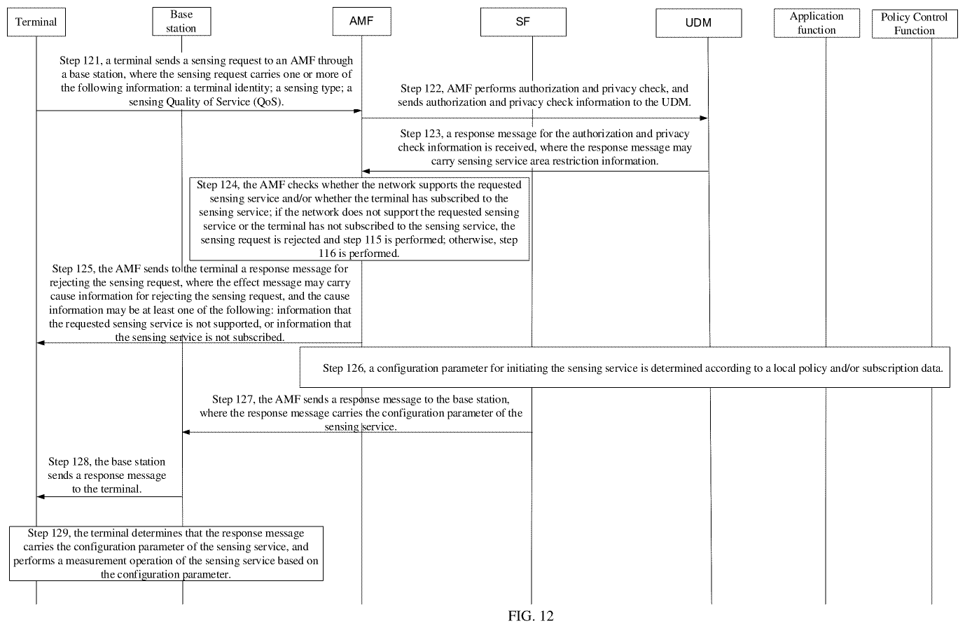

As shown in FIG. 12, an embodiment provides a method for initiating a sensing service. The method includes:

In step 121, a terminal sends a sensing request to an AMF through a base station. The sensing request carries one or more of the following information: a terminal identity; a sensing type; a sensing Quality of Service (QoS).

In step 122, AMF performs authorization and privacy check, and sends authorization and privacy check information to the UDM.

In step 123, a response message for the authorization and privacy check information is received. The response message may carry sensing service area restriction information.

In step 124, the AMF checks whether the network supports the requested sensing service and/or whether the terminal has subscribed to the sensing service. If the network does not support the requested sensing service or the terminal has not subscribed to the sensing service, the sensing request is rejected and step 115 is performed; otherwise, step 116 is performed.

In step 125, the AMF sends to the terminal a response message for rejecting the sensing request. The response message may carry cause information for rejecting the sensing request, and the cause information may be at least one of the following: information that the requested sensing service is not supported, or information that the sensing service is not subscribed.

In step 126, a configuration parameter for initiating the sensing service is determined according to a local policy and/or subscription data.

In step 127, the AMF sends a response message to the base station. The response message carries the configuration parameter of the sensing service. Here, the configuration parameter may include a configuration parameter for a transmitter of the terminal to send a transmission wave and/or a configuration parameter for a receiver of the terminal to receive a reflected wave.

In step 128, the base station sends a response message to the terminal.

In step 129, the terminal determines that the response message carries the configuration parameter of the sensing service, and performs a measurement operation of the sensing service based on the configuration parameter.

It should be noted that those skilled in the art can understand that the methods provided in the embodiments of the present disclosure may be performed alone or may be performed together with some methods in the embodiments of the present disclosure or some methods in related art.

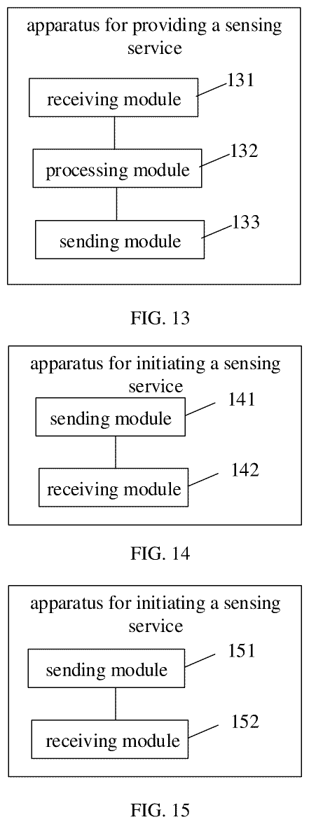

As shown in FIG. 13, an embodiment of the present disclosure provides an apparatus for providing a sensing service. The apparatus includes a receiving module 131, a processing module 132 and a sending module 133.

The receiving module 131 is configured to receive a sensing request, where the sensing request is used to request a sensing service.

The processing module 132 is configured to: obtain sensing service area restriction information, where the sensing service area restriction information is used to indicate an area where the sensing service is forbidden and/or allowed to be initiated; and perform a predetermined operation according to the sensing service area restriction information, where the predetermined operation includes: accepting the sensing request or rejecting the sensing request.

The sending module 133 is configured to send a response message for the perception service to the access network device, where the response message carries information for rejecting the sensing request or a configuration parameter of the sensing service.

It should be noted that those skilled in the art can understand that the methods provided in the embodiments of the present disclosure may be performed alone or may be performed together with some methods in the embodiments of the present disclosure or some methods in related art.

As shown in FIG. 14, an embodiment of the present disclosure provides an apparatus for initiating a sensing service. The apparatus includes a sending module 141 and a receiving module 142.

The sending module 141 is configured to send a sensing request, where the sensing request is used for requesting a sensing service.

The receiving module 142 is configured to receive a response message, where the response message carries information for rejecting the sensing request or a configuration parameter of the sensing service.

It should be noted that those skilled in the art can understand that the methods provided in the embodiments of the present disclosure may be performed alone or may be performed together with some methods in the embodiments of the present disclosure or some methods in related art.

As shown in FIG. 15, an embodiment of the present disclosure provides an apparatus for initiating a sensing service. The apparatus includes a sending module 151 and a receiving module 152.

The sending module 151 is configured to send a sensing request to a core network device, where the sensing request is used to request a sensing service.

The receiving module 152 is configured to receive a response message for the sensing service sent by the core network device, where the response message carries information for rejecting the sensing request or a configuration parameter of the sensing service.

It should be noted that those skilled in the art can understand that the methods provided in the embodiments of the present disclosure may be performed alone or may be performed together with some methods in the embodiments of the present disclosure or some methods in related art.

An embodiment of the present disclosure provides a communication device. The communication device includes:
a processor; and
a memory for storing instructions executable by the processor;
where the processor is configured to, when the executable instructions are run, implement the method applied to any embodiment of the present disclosure.

The memory may include storage mediums of various types, which are non-transitory computer storage mediums, and can continue to memorize information stored thereon after the communication device is powered off.

The processor may be connected to the memory via a bus or the like to read the executable program stored in the memory.

An embodiment of the present disclosure further provides a computer storage medium, wherein the computer storage medium stores a computer executable program, and when the executable program is executed by a processor, the method of any embodiment of the present disclosure is implemented.

Regarding the apparatuses in the above embodiments, the specific manner in which each module performs operations has been described in detail in the embodiments of the methods, and will not be elaborated here.

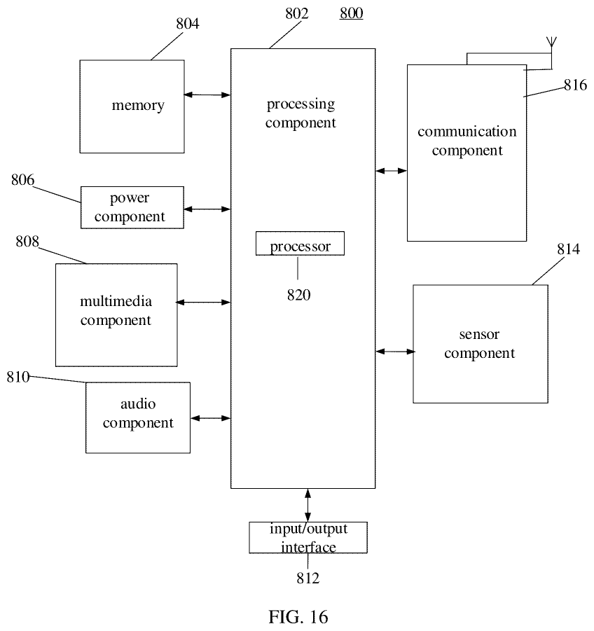

As shown in FIG. 16, an embodiment of the present disclosure provides a structure of a terminal.

Referring to a terminal 800 in FIG. 16, an embodiment of the present disclosure provides a terminal 800. The terminal 800 may be a mobile phone, a computer, a digital broadcast terminal, a messaging device, a gaming console, a tablet, a medical device, exercise equipment, a personal digital assistant, and the like.

Referring to FIG. 16, the terminal 800 may include one or more of the following components: a processing component 801, a memory 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal 800. Examples of such data include instructions for any applications or methods operated on the terminal 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 800 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 800. For instance, the sensor component 814 may detect an open/closed status of the terminal 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal 800 and other devices. The terminal 800 can access a wireless network based on a communication standard, such as WiFi, 2G, or 3G, or a combination thereof. In one example embodiment, the communication component 816 receives a broadcast signal or broadcast associated information from an external broadcast management system via a broadcast channel. In one example embodiment, the communication component 2908 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the terminal 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the terminal 800, for performing the above-described methods. For example, the non-transitory computer-readable storage medium may be a ROM, a Random Access Memory (RAM), a CD-ROM, a magnetic tape, a floppy disc, an optical data storage device, and the like.

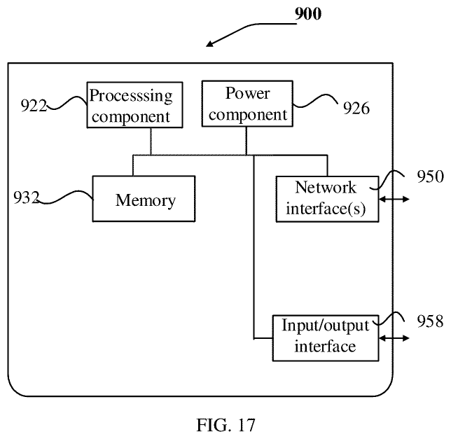

As shown in FIG. 17, an embodiment of the present disclosure shows a structure of a base station. For example, a base station 900 may be provided as a network side device. Referring to FIG. 17, the base station 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform the above described methods which are applied at the base station.

The base station 900 may also include a power component 926 configured to perform power management of the base station 900, wired or wireless network interface(s) 950 configured to connect the device 800 to a network, and an input/output (I/O) interface 958. The base station 900 may operate based on an operating system stored in the memory 932, such as Windows Server™, Mac OS X™, Unix™, Linux™, FreeBSD™, or the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A method for providing a sensing service, wherein the method is performed by a core network device and comprises:
receiving a sensing request sent by an access network device, wherein the sensing request is configured to request the sensing service;
obtaining sensing service area restriction information, wherein the sensing service area restriction information indicates at least one of an area where the sensing service is forbidden to be initiated, or an area where the sensing service is allowed to be initiated;
performing a predetermined operation according to the sensing service area restriction information, wherein the predetermined operation comprises: accepting the sensing request or rejecting the sensing request; and
sending a response message for the sensing service to the access network device, wherein the response message carries information for rejecting the sensing request or a configuration parameter of the sensing service.

2. The method according to claim 1, wherein performing the predetermined operation according to the sensing service area restriction information comprises:
determining that at least one of a terminal or a base station is in the area where the sensing service is forbidden to be initiated, and rejecting the sensing request; or
determining that at least one of the terminal or the base station is in the area where the sensing service is allowed to be initiated, and accepting the sensing request.

3. The method according to claim 2, further comprising:
determining to accept the sensing request, and determining the configuration parameter for initiating the sensing service according to a predetermined rule.

4. The method according to claim 2, further comprising:
determining to reject the sensing request, wherein the response message carries information for rejecting the sensing request; or
determining to accept the sensing request, wherein the response message carries the configuration parameter of the sensing service.

5. The method according to claim 1, wherein the method further comprises one or more of:
determining that a core network does not support the requested sensing service, and rejecting the sensing request;
determining that a terminal does not subscribe to the sensing service, and rejecting the sensing request;
determining that the core network is not capable of providing the sensing service, and rejecting the sensing request;
determining that the terminal supports the requested sensing service, and accepting the sensing request;
determining that the terminal has subscribed to the sensing service, and accepting the sensing request; and
determining that the core network is capable of providing the sensing service, and accepting the sensing request.

6. The method according to claim 1, wherein the sensing request carries one or more of:
a terminal identity;
a sensing type; and
a sensing Quality of Service (QoS).

7. A method for initiating a sensing service, wherein the method is performed by a terminal, and comprises:
sending a sensing request to an access network device, wherein the sensing request is configured to request the sensing service; and
receiving a response message for the sensing service sent by the access network device, wherein the response message carries information for rejecting the sensing request or a configuration parameter of the sensing service.

8. The method according to claim 7, further comprising:
determining that the response message carries the configuration parameter of the sensing service, and performing a measurement operation of the sensing service based on the configuration parameter.

9. A method for initiating a sensing service, wherein the method is performed by an access network device, and comprises:
sending a sensing request to a core network device, wherein the sensing request is configured to request the sensing service; and
receiving a response message for the sensing service sent by the core network device, wherein the response message carries information for rejecting the sensing request or a configuration parameter of the sensing service.

10. The method according to claim 9, further comprising:
determining that the response message carries the configuration parameter of the sensing service, and performing a measurement operation of the sensing service based on the configuration parameter.

11-13. (canceled)

14. A communication device, comprising:
a memory; and
a processor connected to the memory, wherein the processor is configured to perform the method according to claim 1.

15. A non-transitory computer storage medium storing computer executable instructions that, when executed by a processor, cause the processor to perform the method according to claim 1.

16. A communication device, comprising:
a memory; and
a processor connected to the memory, wherein the processor is configured to perform the method according to claim 7.

17. A communication device, comprising:
a memory; and
a processor connected to the memory, wherein the processor is configured to perform the method according to claim 9.

18. A non-transitory computer storage medium storing computer executable instructions that, when executed by a processor, cause the processor to perform the method according to claim 7.

19. A non-transitory computer storage medium storing computer executable instructions that, when executed by a processor, cause the processor to perform the method according to claim 9.
